(19) United States
(12) Patent Application Publication
(10) Pub. No.: US 2007/0165975 A1
(43) Pub. Date: Jul. 19, 2007

(54) Axial, rotational and angular motion ball bearing

(76) Inventor: John Brodowski, Smithtown, NY (US)

Correspondence Address: JOHN BRODOWSKI, 81 MOBREY LANE, SMITHTOWN, NY, 11787, US

(21) Appl. No.: 11/635,720

(22) Filed: Dec. 8, 2006

Related U.S. Application Data
(60) Provisional application No. 60/749,107, filed on Dec. 12, 2005.

(51) Int. Cl. F16C 23/08

(52) U.S. Cl. 384/495

(57) ABSTRACT

A single design ball bearing assembly for multipurpose use is presented. A split outer race which consists of two identical hemispherical parts allows this bearing assembly to be constructed and assembled with a variety of ball and shaft designs. Ball and shaft serve as an inner race in prior-art designs. A partition between each identical hemispherical outer race (housing) keeps ball bearings in each outer race from migrating into each other. A hemispherical outer race having a free zone channel permits the ball bearings to roll into and out of the free zone channel during angular motion of the ball and shaft, similar to the motion of present-art linear bearings where ball bearings roll and translate into and out of specially constructed channels. The free zone channel's cross section is slightly larger than the ball bearings' diameter in order to allow the ball bearings' free motion in the channel. During rotational motion of the ball and shaft, the ball bearings mimic the motion of present art roller bearings. Each housing has a specially designed lip to retain ball bearings in the assembly.

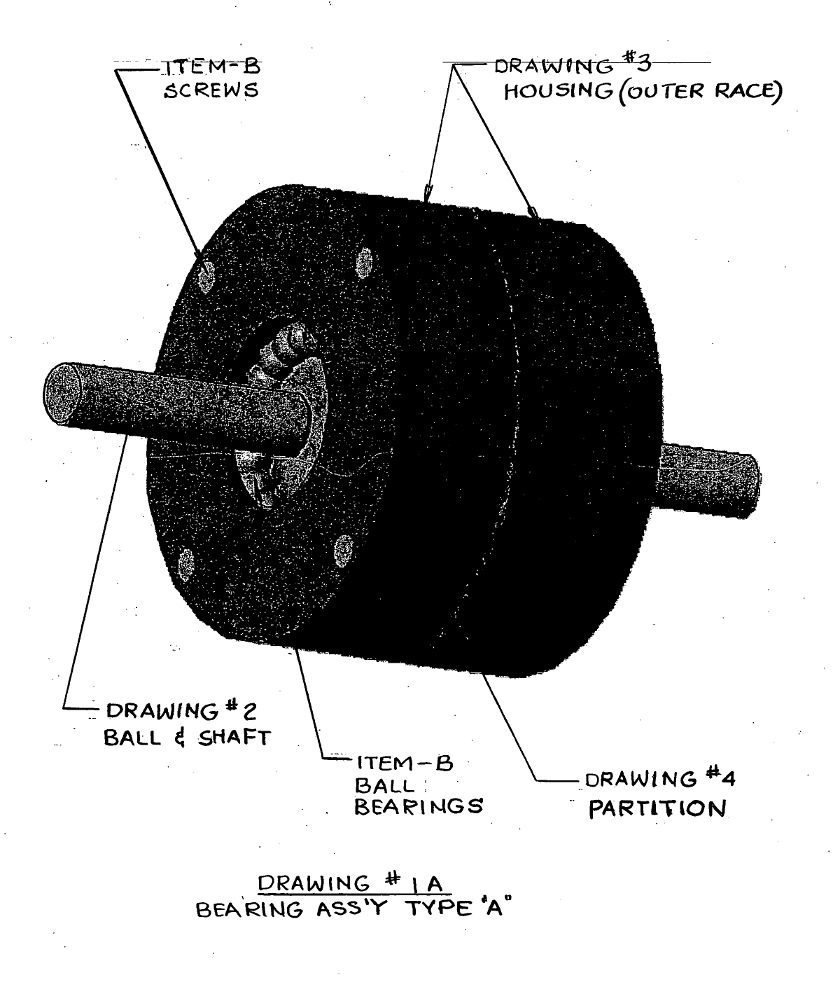

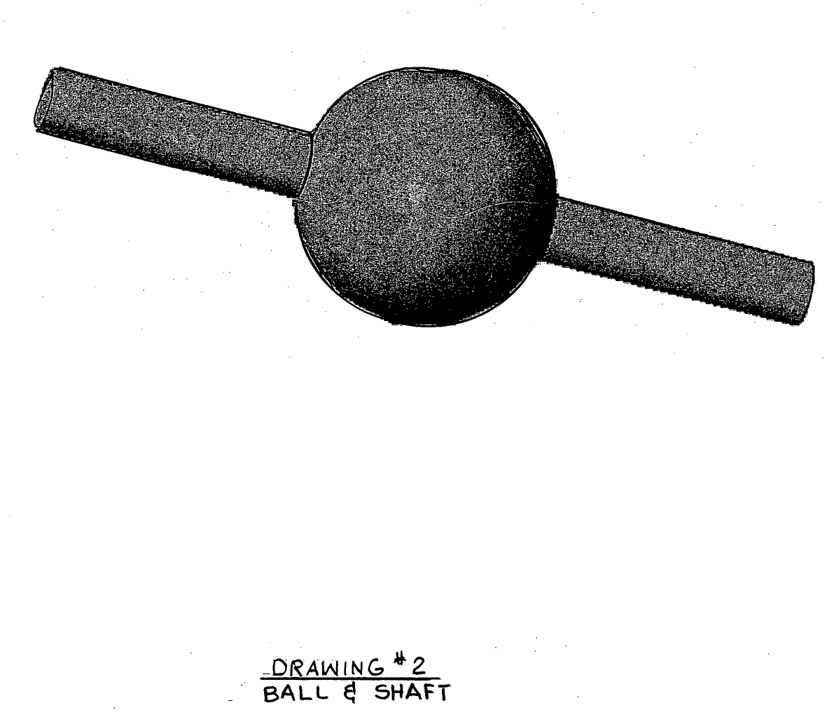

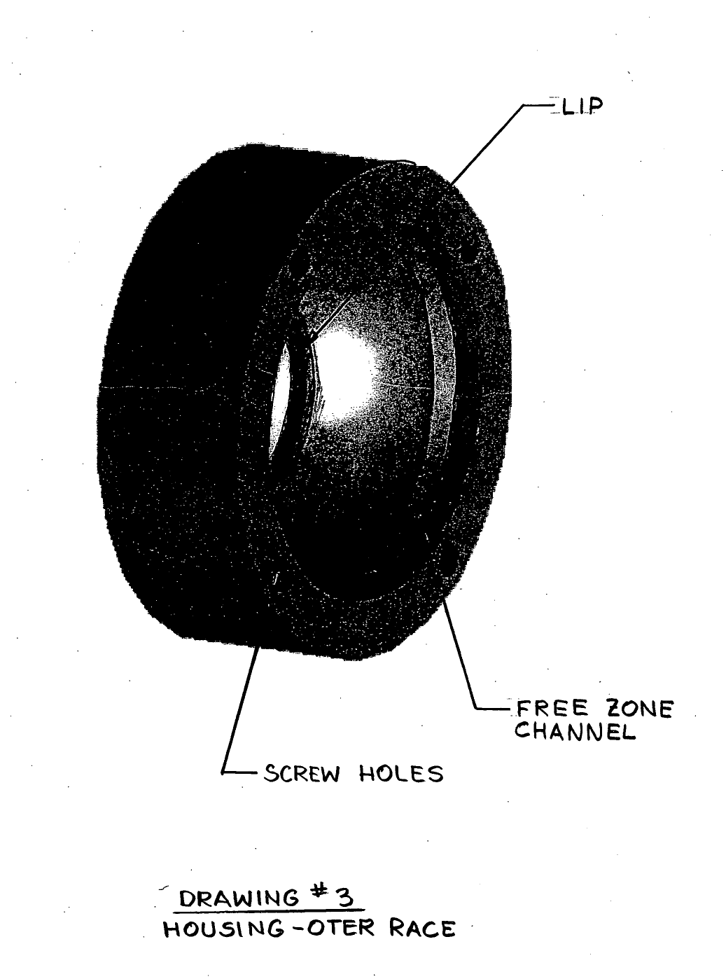

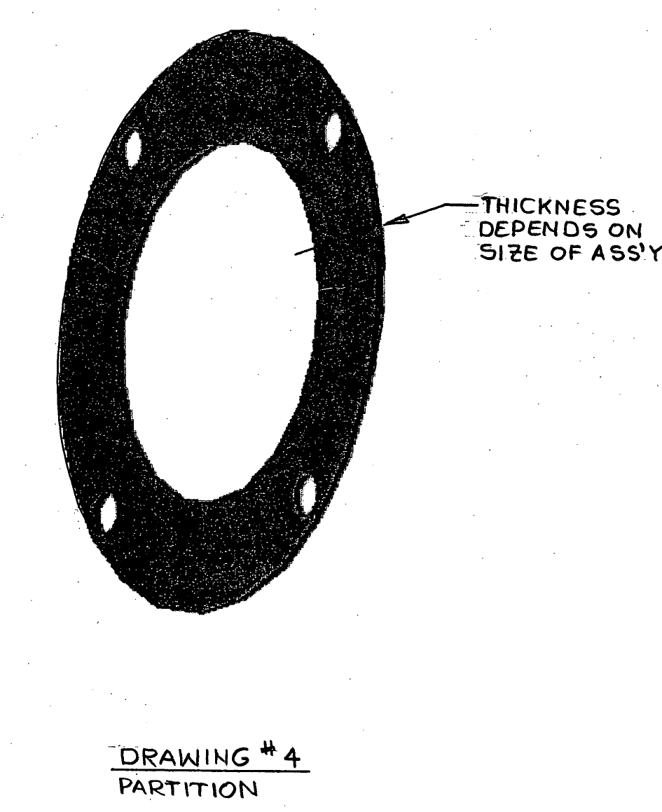

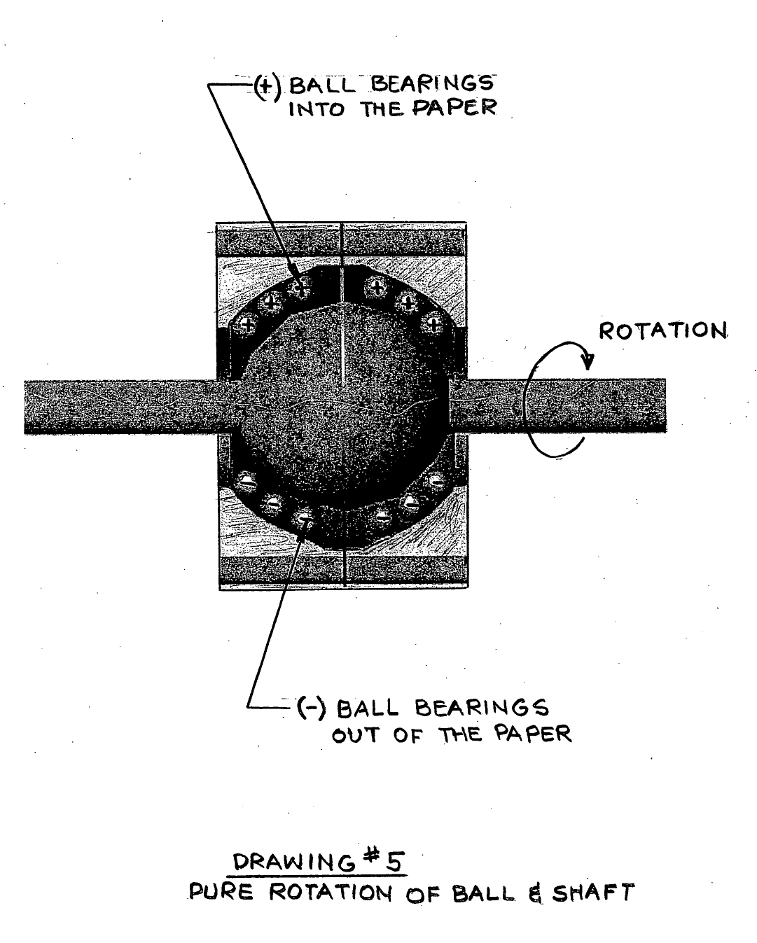

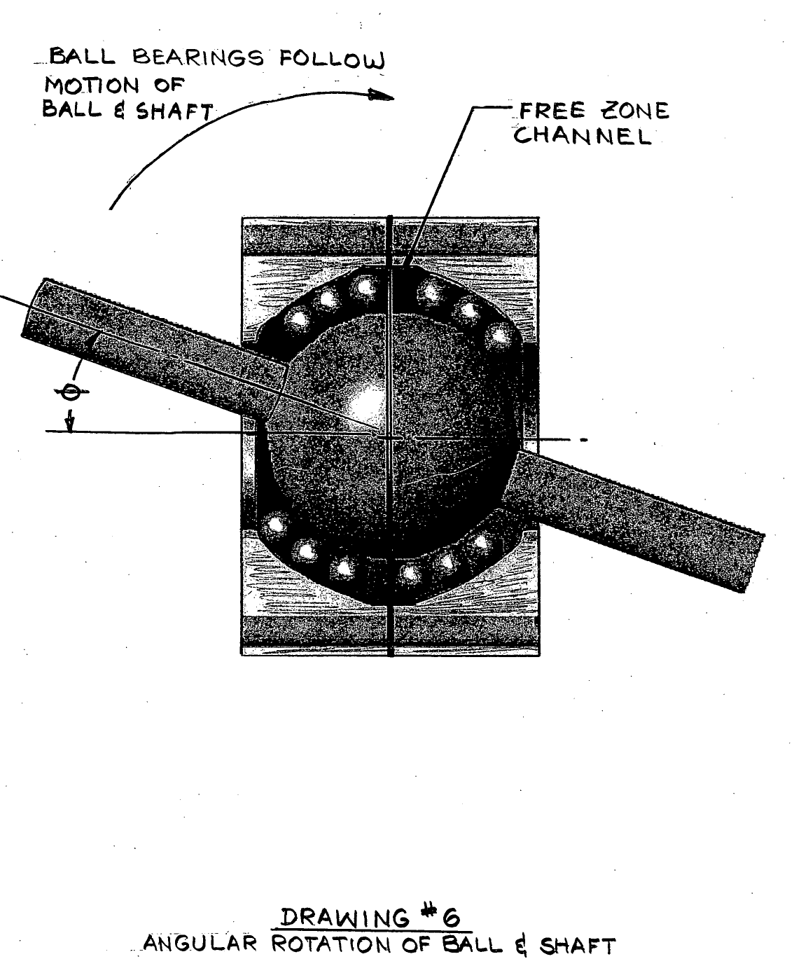

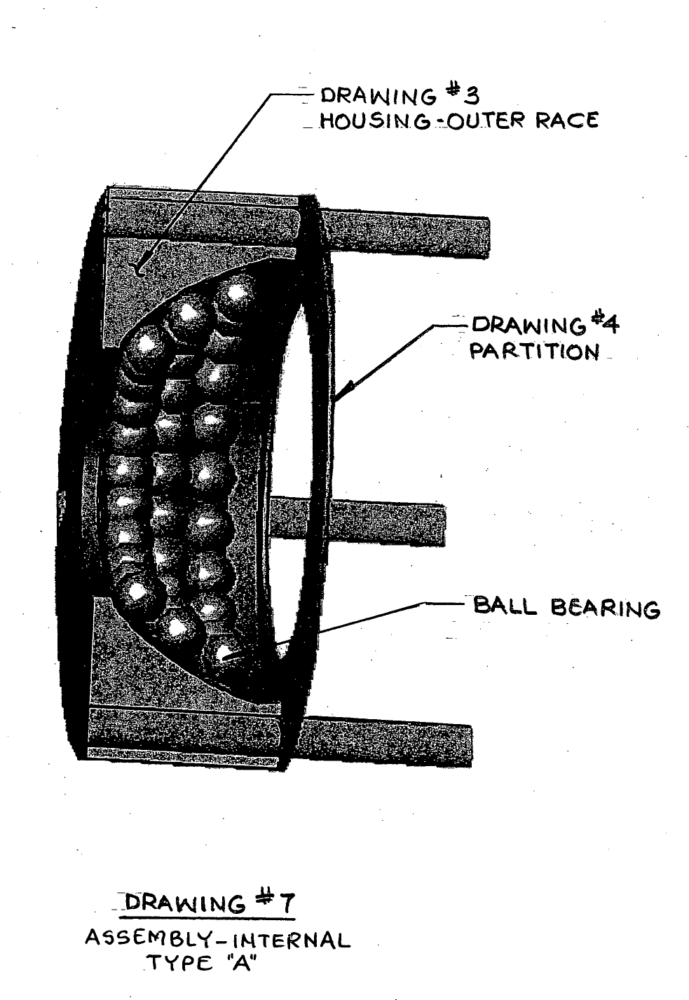

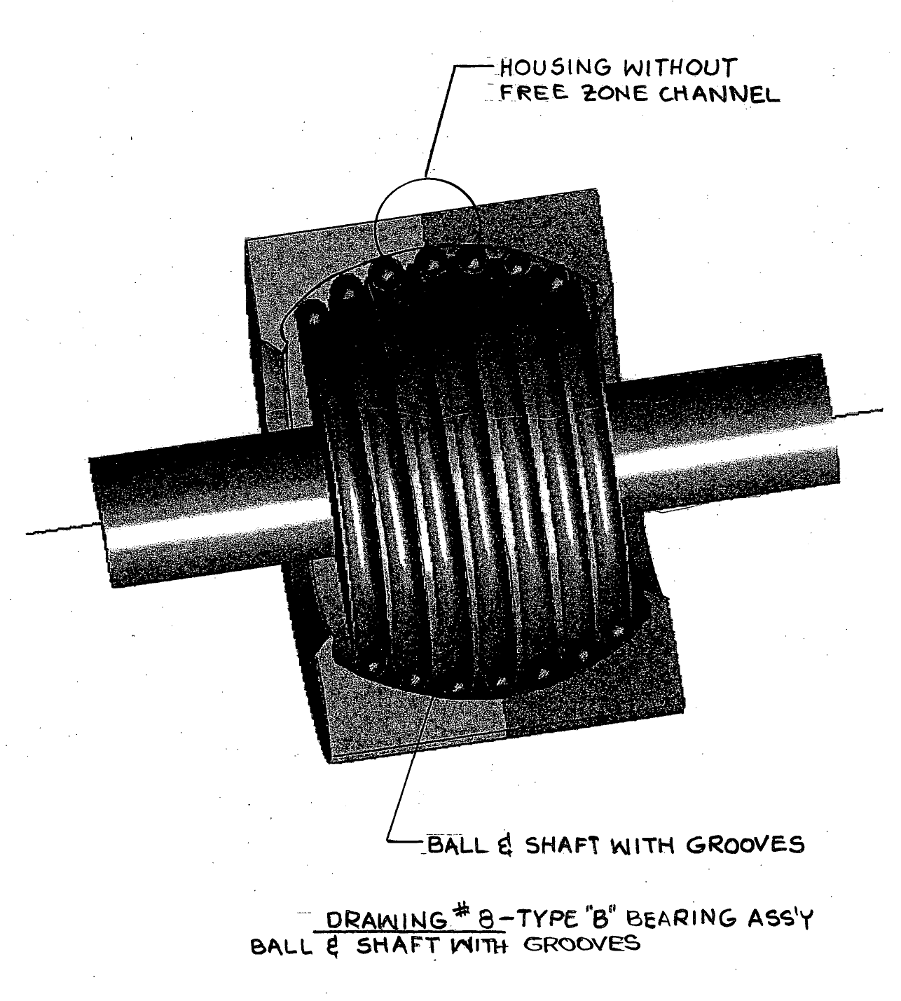

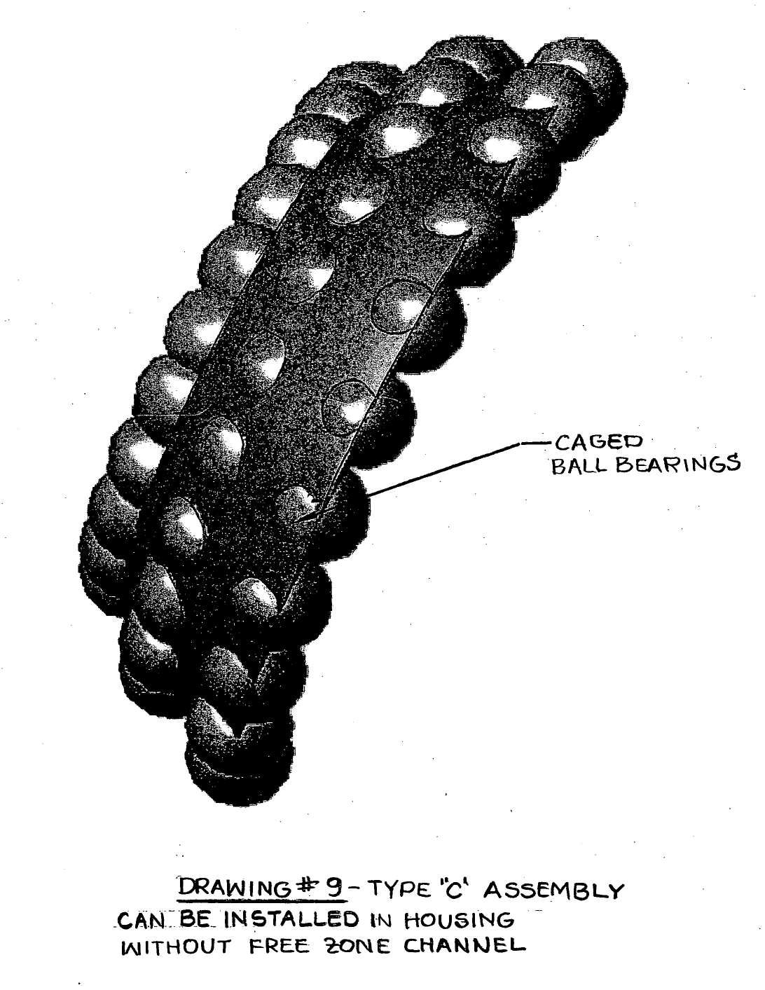

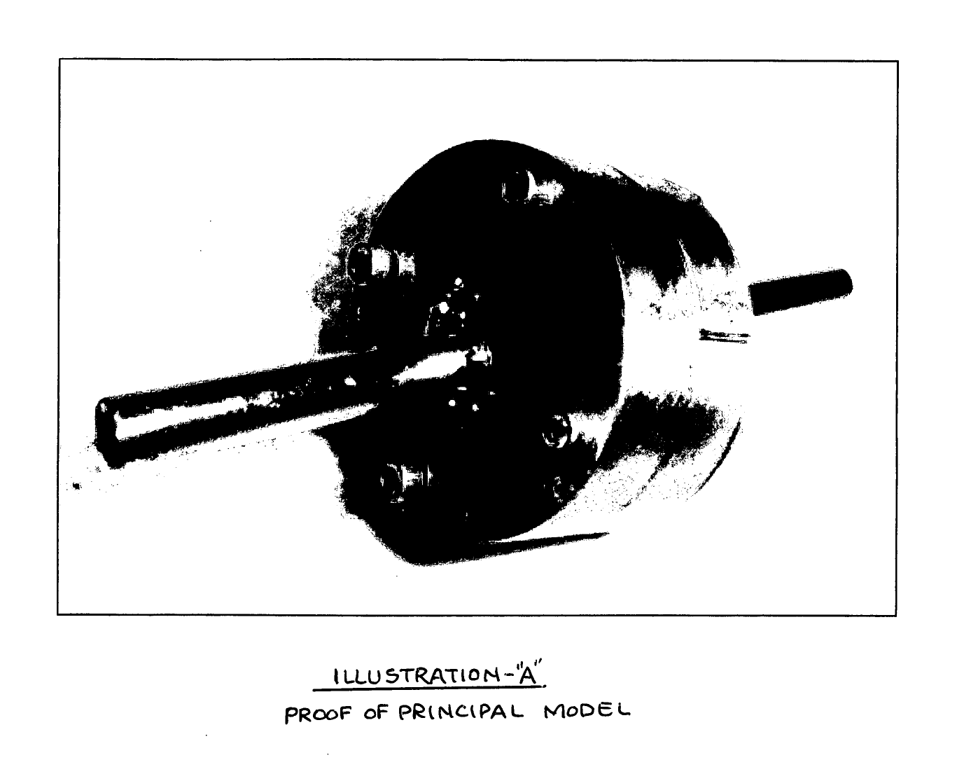

Two identical hemispherical outer races (housings) “clamp” the entire bearing assembly and hold the ball and shaft and ball bearings in place. A large number of ball bearings (Drawing #7) in this design allows large radial and thrust loads to be applied to the shaft unlike present-art self aligning bearings, which have only one row of ball bearings to absorb applied loads.

### DETAILED DESCRIPTION

The bearing assembly (Drawing #1A, Type A) includes ball and shaft (Drawing #2), two identical hemispherical outer races (Drawing #3), partition (Drawing #4), ball bearings (Item A) and screws (Item B).

Rivets, screws or electron beam welding can be used as an alternate method to assemble this bearing. A detailed drawing of the outer race is shown on Drawing #3.

Each outer race has two important features: a free zone channel and a lip. The ball bearings, depicted on Drawing #1A, Type A, can flow into and out of the free zone during angular motion. The lip contains and prevents the ball bearings from falling out of the assembly. The partition (Drawing #4) stops the ball bearings from migrating from one outer race into another outer race and therefore maintains the same number of ball bearings in each half of the bearing assembly.

Each bearing assembly (Drawing #1A) must have a specific number of ball bearings for optimum function of each bearing assembly. It is also important that each half of the bearing assembly must not have a full complement of ball bearings. If both halves of the bearing assembly were completely filled with ball bearings, the flow of the ball bearings would be impeded and cause the bearing assembly to fail. During rotational motion of the ball and shaft, (Drawing #5) the ball bearings mimic the motion of prior-art roller bearings. During angular motion of the ball and shaft, angle (Drawing #6), the ball bearings have motion similar to that of linear bearing assemblies, where ball bearings rotate and translate in specially designed channels. In this design, the free zone channel performs this function. During combined angular and rotational motion of the ball and shaft, the ball bearings have a combined motion, as described in the above paragraphs. Two hemispherical outer races firmly capture the ball and shaft in the assembly; by this very fact, large simultaneous thrust and radial loads can be applied to the shaft. At the same time, the shaft is capable of large angular displacement, which is not possible with prior-art, self-aligning bearings. This design allows angular displacement of ±22° while prior-art self-aligning bearings can be displaced by no more than ±4°.

The spherical outer housing design allows this ball bearing assembly (Drawing #1A, Type A) to be constructed with a variety of different designs. Type B bearing assembly with grooved ball and shaft design is shown on Drawing #8. The outer housing in this design does not have a free zone channel and partition. Angular displacement in this design is not as large as in the design having a free zone and partition, but because of the large number of ball bearings, its load capacity is large. Type C (Drawing #9) ball bearing assembly can be constructed with an outer housing without a free zone channel and without partition. The ball bearings in this design are captured in a cage.

### DRAWING DESCRIPTION

Drawing #1 Bearing Assembly

Drawing #2 Ball and Shaft

Drawing #3 Housing—Outer Race

Drawing #4 Partition

Drawing #5 Description of Rotational Ball Bearing Movement in the Assembly.

Drawing #6 Description of Angular Ball Bearing Movement in the Assembly.

Drawing #7 Internal Assembly of Type A Bearing

Drawing #8 Bearing Assembly Type B

Drawing #9 Bearing Type C with Caged Ball Bearings

Illustration A Proof of Principle Model

1. Ball bearing assembly (Drawing #1, Type A) comprising of two identical hemispherical outer housings (Drawing #3), ball and shaft (Drawing #2), partition (Drawing #4.)

2. (c) Said ball bearing assembly having a free zone channel machined in each outer hemispherical housing which permits the ball bearings' free movement during angular translation of the ball and shaft.

3. (d) Said ball bearing assembly having lips machined in outer housings which retain the integrity of the ball bearing assembly.

4. Said ball bearing assembly having ball and shaft which acts as an inner race.

5. (e) Said ball bearing assembly having a partition which prevents the ball bearings' migration between the housings and retains the same number of ball bearings in each housing.

6. (a) Said ball bearing assembly having two identical hemispherical outer housings.

7. Ball bearing assembly (Drawing #8, Type B) consisting of two identical hemispherical pouter housings and grooved ball and shaft but but and without partition.

8. Ball bearing assembly (Drawing #9, Type C) consisting of two identical hemispherical outer housings, ball and shaft but containing caged ball bearings.
